(19) United States
(12) Patent Application Publication
(10) Pub. No.: US 2002/0018883 A1
(43) Pub. Date: Feb. 14, 2002

(54) Thermoplastic resin film and production process thereof, and optical film

(76) Inventors: Iwao Okazaki, Kyoto-shi (JP); Kenji Tsunashima, Kyoto-shi (JP); Yutaka Harada, Osaka (JP)

Correspondence Address: KUBOVCIK & KUBOVCIK, SUITE 710, 900 17TH STREET NW, WASHINGTON, DC, 20006

(21) Appl. No.: 09/886,988

(22) Filed: Jun. 25, 2001

(30) Foreign Application Priority Data
Jul. 5, 2000 (JP) 203338/00

(51) Int. Cl. B32B 27/36

(52) U.S. Cl. 428/220; 428/515; 428/412; 428/480; 264/466

(57) ABSTRACT

A thermoplastic resin film includes at least a thermoplastic resin A having a glass transition temperature of equal to or higher than 150° C., and this film has a thickness equal to or more than 30 μm, a retardation less than or equal to 20 nm, an enthalpy relaxation temperature from 140° C. to 200° C. and an enthalpy relaxation magnitude from 0.01 to 2.0 kJ/mol. This film has good surface flatness, low retardation and satisfactory thermal dimensional stability, and can be advantageously used as a substrate of liquid crystal display device.

### BACKGROUND OF THE INVENTION

1. Field of the Invention

The present invention relates to a thermoplastic resin film, to an optical film and to a process for producing the thermoplastic resin film.

2. Description of the Related Art

Thermoplastic resin films are light in weight and resistant to cracking, and have been recently used in liquid crystal display devices for mobile data terminals. Demands have therefore been made to provide thermoplastic resin films that can be used as substrates of liquid crystal display device substrates for color display.

When such thermoplastic resins are used as substrates of liquid crystal display devices, they must have equivalent characteristics to those of conventional glasses. Such characteristics include, for example, colorlessness and transparency, high light transmittance, and other optical properties, heat resistance that can be resistant to processes such as lamination of transparent electrodes or oriented films, and thermal dimensional stability. Most of these characteristics are derived from the inherent characteristics of constitutional resins, and a variety of novel resins have been developed, such as norbornene-based polymers (e.g., U.S. Pat. No. 2,883,372), and ring-opening polymers of dicyclopentadiene, and other alicyclic polyolefins.

However, the transparent electrodes formed on the substrates of liquid crystal display devices for color display must have lower resistance, and therefore the constitutive resins must have high thermal dimensional stability. Specifically, if the resins have insufficient thermal dimensional stability, and films having a thickness of equal to or more than 30 μm and being formed by melting of these resins are used as substrates of liquid crystal display devices, the formed transparent electrodes are peeled off or cracked and fail to achieve lower resistance. Additionally, these films must be somewhat thick, and such thick films become curling when the resins are continuously formed into films and are wound.

### SUMMARY OF THE INVENTION

Specifically, the present invention provides, in an aspect, a thermoplastic resin film including at least a thermoplastic resin A having a glass transition temperature of equal to or higher than 150° C., and the thermoplastic resin film has a thickness of equal to or more than 30 μm, a retardation of less than or equal to 20 nm, an enthalpy relaxation temperature of from 140° C. to 200° C. and an enthalpy relaxation magnitude of from 0.01 to 2.0 kJ/mol.

In another aspect, the present invention provides a process for producing a thermoplastic resin film, which process includes the steps of laminating a Layer B composed of a thermoplastic resin B at least on one side of a Layer A composed of a thermoplastic resin A by melt co-extrusion, which thermoplastic resin A has a glass transition temperature of equal to or higher than 150° C.; and peeling off the Layer B to thereby yield a thermoplastic resin film having a thickness of equal to or more than 30 μm, a retardation of less than or equal to 20 nm, an enthalpy relaxation temperature of from 140° C. to 200° C. and an enthalpy relaxation magnitude of from 0.01 to 2.0 kJ/mol.

In addition, the present invention relates to a laminate including Layer A composed of a thermoplastic resin A; and Layer C composed of plural layers each having a thermal expansion coefficient lower than the thermal expansion coefficient a of the thermoplastic resin A, and Layer C is laminated on Layer A in such a manner that the plural layers each have a sequentially decreasing thermal expansion coefficient with an increasing distance from Layer A.

### DESCRIPTION OF THE PREFERRED EMBODIMENTS

Thermoplastic resin films of the present invention are advantageously used as optical films. The term “optical films” as used herein means and includes, films for use as members of display devices, such as substrates of liquid crystal display devices, polarizer-protective films, touch-screen supports, and polarizing plates. Particularly, the invented thermoplastic resin films are advantageously used as liquid crystal display device substrates for mobile phone display screens, and personal computer display screens.

The invented thermoplastic resin films must be composed of at least a thermoplastic resin A having a glass transition temperature of equal to or higher than 150° C. If the glass transition temperature is lower than 150° C., the resulting film may be deformed during production process of a liquid crystal display device, such as a process for forming a transparent electrode or oriented film. The thermoplastic resin films may further comprise other layers as described later within ranges not deteriorating the advantages of the present invention.

As the thermoplastic resin A, preferred are alicyclic polyolefins, polycarbonates, polyarylates, polysulfones, and poly(ether sulfone)s, of which alicyclic polyolefins are typically preferred for their satisfactory optical properties. Examples of the alicyclic polyolefins include polymers containing a unit represented by following Formula (1) and/or Formula (2):

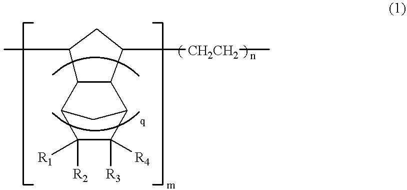

wherein each of R₁, R₂, R₃ and R₄ is independently a hydrogen atom, a hydrocarbon group, or a polar group such as a halogen, an ester, a nitrile or a pyridyl, where R₁ and R₂, or R₃ and R₄ may be combined to form a ring; m is a positive integer; and each of n and q is independently 0 or a positive integer,

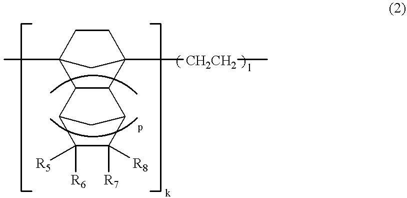

wherein each of R₅, R₆, R₇ and R₈ is independently a hydrogen atom, a hydrocarbon group, or a polar group such as a halogen, an ester, a nitrile, or a pyridyl, where R₅ and R₆, or R₇ and R₈ may be combined to form a ring; k is a positive integer; and each of 1 and p is independently 0 or a positive integer.

Monomers constituting the polymers having the unit of Formula (1) include, but are not limited to, norbornene, and alkyl- and/or alkylidene-substituted derivatives thereof, such as 5-methyl-2-norbornene, 5,6-dimethyl-2-norbornene, 5-ethyl-2-norbornene, 5-butyl-2-norbornene, and 5-ethylidene-2-norbornene; dicyclopentadiene, 2,3-dihydrodicyclopentadiene, and methyl-, ethyl-, propyl-, butyl-, and other alkyl-substituted derivatives, and halogen- and other polar-group-substituted derivatives thereof; dimethanooctahydronaphthalene, and alkyl- and/or alkylidene-substituted derivatives and halogen- or other polar-group-substituted derivatives thereof, such as 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethylidene-1,4:5,8-dimethano-1,4,4a,5,6,7,8,8a-octahydronaphthalene, 6-chloro-1,4:5,8-dimethano-1,4,4a,5,6,7,8,8a-octahydronaphthalene, 6-cyano-1,4:5,8-dimethano-1,4,4a,5,6,7,8,8a-octahydronaphthalene, 6-pyridyl-1,4:5,8-dimethano-1,4,4a,5,6,7,8,8a-octahydronaphthalene, and 6-methoxycarbonyl-1,4:5,8-dimethano-1,4,4a,5,6,7,8,8a-octahydronaphthalene; trimers and tetramers of cyclopentadiene, such as 4,9:5,8-dimethano-3a,4,4a,5,8,8a,9,9a-octahydro-1H-benzoindene, and 4,11:5,10:6,9-trimethano-3a,4,4a,5,5a,6,9,9a,10,10a,11,11a-dodecahydro-1H-cyclopentaanthracene. The polymers having the unit of Formula (1) are prepared by polymerizing one or more of these monomers by ring-opening polymerization, and hydrogenating the resulting ring-opened polymer by a conventional hydrogenation technique.

To obtain a target hydrogenated product (a saturated polymer) of ring-opened polymer, which product has a glass transition temperature of equal to or higher than 150° C., the use of a tetramer or pentamer among these norbornene-based monomers or the combination use of the tetramer or pentamer with a bicyclic or tricyclic monomer is preferred. Specifically, a tetracyclic lower-alkyl-substituted or alkenyl-substituted derivative is preferably used as a base monomer to suppress birefringence.

The polymers having a unit of Formula (2) are polymers obtained by addition polymerization of one or more of the norbornene-based monomers with ethylene, and/or hydrogenated products of these polymers. The polymers having the unit of Formula (2) are saturated polymers.

The alicyclic polyolefins may be copolymers prepared by adding a molecular weight modifier or by adding an additional monomer component as a minor component in the production process of the polymers having a unit of Formula (1) and/or Formula (2). Such molecular weight modifiers include, for example, α-olefins such as 1-butene, 1-pentene and 1-hexene, and the additional monomer components include, for example, cyclopropene, cyclobutene, cyclopentene, cycloheptene, cyclooctene, 5,6-dihydrocyclopentadiene, and other cycloolefins. Preferred alicyclic polyolefins are commercially available under the trade names of “ARTON” from JSR, “ZEONOR” and “ZEONEX” from Nippon Zeon Co., Ltd., and “APEL” from Mitsui Chemicals, Inc.

These alicyclic polyolefins have number average molecular weights within a range from 1×10⁴ to 30×10⁴, and preferably from 2×10⁴ to 20×10⁴, as determined by gel permeation chromatography (GPC) using cyclohexane as a solvent. When unsaturated bonds remained in the molecular chain are saturated by hydrogenation, the degree of hydrogenation is preferably equal to or more than 90%, more preferably equal to or more than 95%, and typically preferably equal to or more than 99%. The resulting saturated polymer has improved thermal dimensional stability.

The melt viscosity of the alicyclic polyolefins for use in the present invention is not specifically limited and is generally less than or equal to 1.5×10⁴ poises, preferably less than or equal to 1.0×10⁴ poises, and more preferably less than or equal to 0.8×10⁴ poises, as determined at a shear rate of 100 sec⁻¹ at 280° C. The alicyclic polyolefin having a melt viscosity within the above range has specifically satisfactory characteristics.

Each of these alicyclic polyolefins can be used alone or in combination in the present invention. Additionally, alicyclic polyolefins of the same type but having different molecular weights may be used in combination as a blend. The alicyclic polyolefins may further comprise additives such as antioxidants, antistatic agents, lubricants, surfactants, and UV absorbers.

In the present invention, the film composed of the thermoplastic resin A must have a thickness of equal to or more than 30 μm. The thickness is preferably equal to or more than 100 μm, and more preferably equal to or more than 200 μm. If the thickness is less than 30 μm, the resulting film has an insufficient rigidity and the film is deformed and has insufficient thermal dimensional stability in the production process of a liquid crystal display device to thereby fail to yield a liquid crystal display device. The upper limit of the film thickness, at which the resulting film has good quality and can be commercially prepared, is about 2000 μm. The film thickness can be controlled by various techniques, but is generally controlled by a metering pump such as a gear pump arranged in the piping for the polymer.

The film composed of the thermoplastic resin A must have a retardation of less than or equal to 20 nm. The retardation is preferably less than or equal to 15 nm, more preferably less than or equal to 10 nm, and typically preferably less than or equal to 5 nm. The film having a retardation within the above range is free from uneven color and is colorless and transparent even when it is used as a substrate of a liquid crystal display device for color display. The lower limit of the retardation is 0 nm. The term “retardation” means the in-plane anisotropy of refractive index and is defined as the product of the difference between refractive indexes in directions perpendicular to each other in plane and the film thickness.

In the production process of the invented thermoplastic resin film, a film composed of a thermoplastic resin B (hereinafter referred to as “Layer B”) is preferably laminated at least on one side of a film composed of the thermoplastic resin A (hereinafter referred to as “Layer A”) in such a manner that Layer B can be peeled off from Layer A. The thermoplastic resin A has a high melt viscosity, and the film often exhibits an excessively high retardation when the film is formed by melting film-formation technique. However, the lamination of a film composed of the thermoplastic resin B can decrease the retardation, as from flow analysis upon melting.

The solution film-formation using a solvent is advantageous in this point, but the solvent must be removed by, for example, drying and the film-formation rate cannot therefore be increased in the solution film-formation. This technique is therefore disadvantageous in point of productivity.

Additionally, the lamination of Layer B can avoid surface defects such as die lines and adhered dust. Layer A and Layer B are preferably laminated in a die or in an adapter during melting and are then co-extruded. To stably cast the melted and co-extruded polymers, Layer A and Layer B are preferably laminated uniformly in the width direction except for the edges of the film. The thickness of Layer B is preferably equal to or more than 2 μm and more preferably equal to or more than 10 μm to achieve lower retardation. The upper limit of the thickness of Layer B for general use is 100 μm, from the viewpoints of the rigidity and other properties of film. The peel force between Layers A and B is preferably equal to or more than 0.05 g/cm and less than 100 g/cm, and more preferably equal to or more than 0.2 g/cm and less than 50 g/cm. If the peel force is equal to or more than 100 g/cm, Layer B cannot be easily peeled off, and if it is less than 0.05 g/cm, the two layers may be peeled off from each other in the film-formation process. The peel force depends on the crystallinity and the degree of crystallinity of the used laminated resins.

The thermoplastic resins B for use in the present invention are not specifically limited but are preferably polyesters or polycarbonates, from the viewpoint of peeling property from the thermoplastic resin A. Among such polyesters, polyesters containing, as a main component, poly(ethylene terephthalate), poly(ethylene naphthalate), poly(ethylene isophthalate) or poly(propylene terephthalate) are preferred, of which polyesters containing poly(ethylene terephthalate) as a main component are specifically preferred.

The term “main component” means that the component in question occupies 80% by weight or more of the polymer, and the polymer may be a copolymer or blend with a third component, as far as the third component occupies less than 20% by weight of the polymer. Dicarboxylic acid components for use as comonomers include, but are not limited to, terephthalic acid, isophthalic acid, 2,6-naphthalenedicarboxylic acid, adipic acid, trimethyladipic acid, sebacic acid, malonic acid, dimethylmalonic acid, succinic acid, glutaric acid, pimelic acid, 2,2-dimethylglutaric acid, azelaic acid, fumaric acid, maleic acid, itaconic acid, 1,3-cyclopentanedicarboxylic acid, 1,2-cyclohexanedicarboxylic acid, 1,4-cyclohexanedicarboxylic acid, 1,4-naphthalic acid (1,4-naphthalenedicarboxylic acid), diphenic acid, 4,4′-hydroxybenzoic acid, and 2,5-naphthalenedicarboxylic acid.

Among these dicarboxylic acids, isophthalic acid, naphthalene dicarboxylic acids, cyclohexanedicarboxylic acids, and diphenylethanedicarboxylic acid are preferred. Diol components for use as comonomers include, but are not limited to, ethylene glycol, diethylene glycol, polyethylene glycol, propylene glycol, polypropylene glycol, 1,3-propanediol, 1,3-butanediol, 1,4-butanediol, 1,5-pentanediol, 1,6-hexanediol, 1,7-heptanediol, 1,8-octanediol, 1,9-nonanediol, 1,10-decanediol, 2,4-dimethyl-2-ethylhexane-1,3-diol, neopentyl glycol, 2-ethyl-2-butyl-1,3-propanediol, 2-ethyl-2-isobutyl-1,3-propanediol, 3-methyl-1,5-pentanediol, 2,2,4-trimethyl-1,6-hexanediol, 1,2-cyclohexanedimethanol, 1,3-cyclohexanedimethanol, 1,4-cyclohexanedimethanol, 2,2,4,4-tetramethyl-1,3-cyclobutanediol, 4,4′-thiodiphenol, bisphenol A, 4,4′-methylenediphenol, 4,4′-(2-norbornylidene)diphenol, 4,4′-dihydroxybiphenol, o-, m-, and p-dihydroxybenzenes, 4,4′-isopropylidenephenol, 4,4′-isopropylidenebis(2,6-dichlorophenol), 2,5-naphthalenediol, p-xylenediol, cyclopentane-1,2-diol, cyclohexane-1,2-diol, and cyclohexane-1,4-diol. Of these diols, propylene glycol, tetramethylene glycol, and cyclohexanedimethanols are preferably used.

The polyester may further comprise p-hydroxybenzoic acid and other hydroxycarboxylic acids as a comonomer component, in addition to the dicarboxylic acid component and diol component. Additionally, the above-exemplified polyesters have a linear structure, but they may be branched polyesters prepared by using an ester-forming component with 3 or higher valency. Polymers constituting blends for use in the present invention include, for example, the polyesters, polyester copolymers (copolyesters), polycarbonate resins, acrylic resins, and polyolefin resins.

The polyester for use as the thermoplastic resin B in the present invention has an intrinsic viscosity of preferably equal to or more than 0.55 dl/g and more preferably equal to or more than 0.6 dl/g. The use of a polyester having an intrinsic viscosity within this range improves flowability upon melting to thereby decrease retardation, and avoids the turn-around of the resin to the edges of the film to thereby yield a uniformly laminated film.

The thermoplastic resin B for use in the present invention may further comprise inactive particles. Such inactive particles include, for example, particles of silica, alumina, calcium carbonate, calcium phosphate, barium sulfate, magnesium oxide, zinc oxide, or titanium oxide, and other inorganic particles; and crosslinked polystyrene particles, acrylic particles, and other organic polymer particles. Additionally, the thermoplastic resin B may further comprise various additives according to necessity. Such additives include, for example, flame retarders, thermostabilizers, plasticizers, antioxidants, UV absorbers, antistatic agents, pigments, and organic lubricants such as fatty acid esters and waxes. Each of these additional components can be used alone or in combination.

The thermoplastic resin A for use in the present invention has an enthalpy relaxation temperature of from 140° C. to 200° C. and preferably from 145° C. to 190° C., and an enthalpy relaxation magnitude of from 0.01 to 2.0 kJ/mol, preferably from 0.02 to 2.0 kJ/mol, and more preferably from 0.05 to 1.5 kJ/mol. After intensive investigations, the present inventors have found that, when a film composed of the thermoplastic resin A is aged so that the enthalpy relaxation temperature and enthalpy relaxation magnitude fall within the above ranges, the resulting film has a sufficient thermal dimensional stability as an optical film such as a substrate of a liquid crystal display device. If the enthalpy relaxation magnitude of the thermoplastic resin A is less than 0.01 kJ/mol, the amorphous structure is insufficiently relaxed to thereby fail to yield satisfactory thermal dimensional stability. In contrast, a practically excessively long aging treatment is required to achieve the enthalpy relaxation magnitude exceeding 2.0 kJ/mol.

The aging treatment is preferably performed at temperatures equal to or higher than [(the glass transition temperature)-30° C.] and less than or equal to the glass transition temperature for equal to or more than 30 minutes, and preferably equal to or more than 2 hours, and less than or equal to about 96 hours. The closer the aging temperature is to the glass transition temperature, the faster the enthalpy is relaxed. Additionally, the aging treatment can also decrease retardation and mitigate curling of the film when the resulting laminate is wound.

After obtaining Layer A covered by Layers B on both sides, Layers B are peeled off, and Layer A is then used as a substrate. For use as an optical film such as a substrate of liquid crystal display device, a polarizer-protective film, a touch-screen support or a polarizing plate, Layer A should preferably have gas barrier property that is resistant to oxygen and water vapor permeation, and abrasion resistance to protect the surface from scratching. To this end, a gas barrier layer, hardcoat layer or another functional layer (hereinafter referred to as “Layer C”) is preferably laminated on the surface of Layer A after peeling off Layers B.

To enhance the adhesion of Layer C to Layer A, the surface of Layer A is very preferably subjected to at least one surface activation treatment prior to the lamination of Layer C. Such surface activation treatments include, but are not limited to, plasma treatment, corona discharge, treatment with chemicals, surface-roughening treatment, etching, and flame treatment.

The gas barrier layer is not specifically limited, and may be a poly(vinyl alcohol) film or a transparent vapor deposition layer such as a silica layer or alumina layer. The gas barrier layer should have moisture resistance, resistance to alkalinity, resistance to acidity, and other properties to achieve satisfactory gas barrier property. Accordingly, the gas barrier layer is preferably prepared by adding a large amount of inorganic fine particles such as silica having an average particle size of from about 5 to about 25 nm to an organic polymeric compound, and crosslinking the resulting layer of organic polymer by heat or electron beam, or by laminating the crosslinked organic polymer layer onto a transparent vapor deposition layer. Such fine particles are not specifically limited, but are preferably silica sol, antimony oxide sol, titania sol, alumina sol, zirconia sol, or tungsten oxide sol. The particles may have an average particle size of from 1 to 300 nm, preferably from 5 to 100 nm, and more preferably from 10 to 50 nm, for use as a transparent film. The content of these particles falls within a range of preferably from 10 to 85% by weight and more preferably from 35 to 70% by weight. These layers may further comprise surfactants.

Preferably, a hard coat layer is then formed on the gas barrier layer. In this case, organic polymers constituting the hard coat layer include, but are not specifically limited to, epoxy resins, acrylic resins, urethane resins, urea resins, melamine resins, and modified derivatives thereof. Additionally, a hard coat composition to form the hard coat layer preferably comprises from about 50 to about 85% by weight of inorganic oxides such as silica each having an average particle size of from about 10 to about 50 nm. The hard coat layer is formed by applying, as the hard coat composition, a water-alcohol dispersion containing the organic polymer, the inorganic oxide and, according to necessity, a catalyst such as an aluminum chelate compound as a crosslinking agent on the gas barrier layer, and crosslinking the applied layer by, for example, heat, electron beam or radiation to thereby form a hard coat layer of a hardness of 3H or more.

Layer C preferably has a thermal expansion coefficient α₂ lower than the thermal expansion coefficient α₁ of Layer A. The thermal expansion coefficient α₂ of Layer C is preferably from 30 to 15 (×10⁻⁶/° C.), which is lower than that of Layer A and higher than that of an inorganic layer such as a transparent electrode layer formed on Layer C. In this connection, an organic layer such as Layer A generally has a high thermal expansion coefficient, and an inorganic layer such as transparent electrode layer generally has a low thermal expansion coefficient.

Layer C may comprise a single layer or plural layers such as two or three layers. For example, Layer C may have a two-layer structure composed of a layer having a thermal expansion coefficient of from about 30 to about 15 (×10⁻⁶/° C.) and a layer having a thermal expansion coefficient of from about 20 to about 10 (×10⁻⁶/° C.). Generally, an organic layer has a high thermal expansion coefficient, and an inorganic layer has a low thermal expansion coefficient, and Layer C may be preferably composed of gradient materials that mitigate the difference of thermal expansion coefficients.

Layer C can be formed by adding large amounts of an inorganic substance into an organic polymeric compound, applying the resulting composition onto the surface of Layer A to thereby form an organic polymer layer containing inorganic substance, and crosslinking the organic polymer layer. Layer C as a gas barrier layer can be formed, for example, in the following manner. Initially, an inorganic oxide having an average particle size of from about 5 to about 25 nm, such as silicon oxide, is added in a proportion of from about 30 to about 65% by weight to a water-alcohol dispersion of a gas barrier organic polymer such as a poly(vinyl alcohol) (PVA), a polyamide (PA) or modified derivative thereof, and additionally, a crosslinking agent such as aluminum chelate compound or another catalyst is added to the dispersion, and the resulting dispersion is applied onto Layer A, and is crosslinked by, for example, heat, electron beam or radiation. The coating technique can be selected from among rotogravure roll coating, metering bar coating, die coating, dipping and other coating processes, depending on the absolute viscosity and the shearing property in viscosity of the coating composition. The applied coating composition can be dried by conventional floating drying process, and the resulting layer may be subjected to knurling to form projections and depressions at edges in the winding operation.

Additionally, an organic polymer layer having a thermal expansion coefficient 2 of from about 20 to about 10 (×10⁻⁶/° C.) containing an inorganic substance can be formed as a hard coat layer by coating in the same manner as above. As organic polymers constituting the hard coat layer, preferred are epoxy resins, acrylic resins, urethane resins, urea resins, melamine resins, and modified derivatives thereof. A hard coat composition to form the hard coat layer may be a water-alcohol dispersion containing the organic polymer, from about 50 to about 85% by weight of an inorganic compound having an average particle size of from about 10 to about 50 nm such as silicon oxide or another metal oxide, and a crosslinking agent such as an aluminum chelate compound or another catalyst. The hard coat composition is applied onto the gas barrier layer, and is crosslinked by heat, electron beam or radiation to thereby form a hard coat layer. The coating technique can be selected from among rotogravure roll coating, metering bar coating, die coating, dipping and other coating processes, depending on the absolute viscosity and the shearing property in viscosity of the coating composition. The applied coating composition can be dried by conventional floating drying process, and the resulting film may be subjected to knurling to form projections and depressions at edges in winding operation.

Two plies of Layer A of the thermoplastic resin A may be bonded to thereby yield a single substrate. The bonding technique includes, but is not specifically limited to, a process in which Layer A composed of an organic resin having a thermal expansion coefficient α₁ is subjected to a surface activation treatment such as plasma treatment, corona discharge, treatment with a chemical agent, surface roughening treatment, etching, or flame treatment, and two treated surfaces with each other or a treated surface and a non-treated surface are bonded by thermocompression; a process in which an adhesive is applied onto two plies of Layer A and the two plies are then bonded with each other; and a process in which a layer of a polymer substantially the same with the thermoplastic resin A is molten and extruded into between two plies of Layer A, and these three layers are bonded with each other by thermocompression. The surface activation process, in which Layer A is subjected to a surface activation treatment, is preferred, from the viewpoints of productivity and quality of the resulting product. When plural plies of Layer A are bonded with each other to form the invented multilayer laminate, the bonded plural plies of Layer A are assumed as one Layer A in the invented configuration.

Next, a process for producing the invented thermoplastic resin film will be illustrated with reference to an example below, which is not intended to limit the scope of the invention.

Initially, low molecular weight fractions having a molecular weight of less than 100, such as water, volatile substances, and decomposed substances are removed from the thermoplastic resin A to thereby control the content of these low molecular weight fractions to preferably less than or equal to 0.05% by weight, and the resulting thermoplastic resin A is fed to an extruder and is melted. Separately, low molecular weight fractions such as water are also removed from the thermoplastic resin B, and the resulting thermoplastic resin B is fed to another extruder, is melted, and is laminated with the molten thermoplastic resin A (Layer A) in a complex die or an adapter. In this procedure, the thermoplastic resin B is preferably laminated on both sides of the layer of thermoplastic resin A, in order to decrease retardation, from flow analysis upon melting. The laminate of thermoplastic resins is discharged from the die and is brought into close contact with a cooling drum to thereby yield a cast sheet. The laminate can be cast by, for example, air knife process, air chamber process, pressing roll process, liquid paraffin coating process, electro-pinning application process, and calendering, of which electro-pinning application process is typically preferred. A preferred drum is composed of chromium-plated material or stainless steel and has a surface roughness Rₘₐₓ of less than or equal to 0.2 μm is preferred. The surface temperature of the drum is not specifically limited and depends on the crystallinity and adhesion to the drum of the thermoplastic resin B and on optical properties of the thermoplastic resin A, but generally falls within a range from 20° C. to 180° C. and preferably from 40° C. to 150° C. The draft ratio (the ratio of the die aperture to the thickness of solidified film) is preferably less than or equal to 20, and more preferably less than or equal to 10, since the smaller the draft ratio is, the more optically isotropic the resulting film is.

On the thermoplastic resin film obtained according to the present invention, a gas barrier layer, hard coat layer, and/or readily-adhesive layer is formed according to necessity, and a transparent electrode is formed thereon to thereby yield a substrate of a liquid crystal display device.

After the formation of these layers, the resulting laminate is cut into a sheet. The sheet is typically preferably aged at a temperature lower than or equal to the glass transition temperature under an appropriate load in the above manner, for avoiding curling, relaxing molecular orientation or improving thermal dimensional stability.

[Measuring Methods of Physical Properties and Evaluation Methods Thereof]

The physical properties (characteristics) in the present invention are measured and evaluated by the following methods.

(1) Retardation

A sample film was placed in a polarizing microscope equipped with crossed Nicol using the sodium D-line (589 nm) in such a manner that the plane of the film is perpendicular to the optical axis, and the retardation Rd caused by birefringence n of the sample film was determined from the compensation of a compensator.

(2) Surface Roughness

The center-line-average height (roughness) Ra was determined using a three-dimensional surface roughness tracer (available from Kosaka Laboratory Ltd., under the trade name of ET-30 HK). The measuring condition was as follows. The surface roughness was defined as the mean of 20 measurements.

Stylus tip radius: 2 μm

Stylus load: 16 mg

Measured area: 0.3 mm²

Cut-off: 0.25 mm

(3) Laminate Thickness and Film Thickness

A sample laminated film was peeled off into individual layers, and the thickness of the individual layers was measured with a dial gauge.

(4) Intrinsic Viscosity

The melt viscosity of a sample was determined in o-chlorophenol at 25° C., and the intrinsic viscosity was calculated from the melt viscosity according to the following equation:

ηₛₚ/C=[72 ]+2K[η]C

wherein ηₛₚ=[(viscosity of solution)/(viscosity of solvent)]−1; C (g/100 ml) is the weight of dissolved polymer in 100 ml of the solvent; and K is the Huggins constant (0.343). The viscosity of solution and the viscosity of solvent were determined using an Ostwald viscometer.

(5) Glass Transition Temperature and Enthalpy Relaxation Temperature

About 5 mg of a sample was placed on an aluminum pan to yield a test piece, and the test piece was held at 300° C. for 5 minutes and was quenched in liquid nitrogen, and the glass transition temperature and the enthalpy relaxation temperature were determined at a temperature rising rate of 20° C./minute, using a differential scanning colorimeter (DSC) and a data analyzer (both available from Seiko Instruments Inc., under the trade names of “RDC 220” and “SSC/5200”, respectively).

The glass transition temperature was defined as the midpoint temperature during glass transition, and the enthalpy relaxation temperature was defined as the temperature of the peak of enthalpy relaxation. The enthalpy relaxation magnitude was calculated from the peak area of enthalpy relaxation.

(6) Thermal Dimensional Stability (Thermal Dimensional Changing Temperature)

Using a thermomechanical analyzer (TMA), a sample was raised in temperature from 30° C. to 300° C. at a rate of 20° C./min., and a plot of temperature (abscissa) versus dimensional change (ordinate) was made, and the thermal dimensional changing temperature was defined as the point at which the plot deviates from a straight line at or below the glass transition temperature.

(7) Amount of Curing

In a sample film 300 mm times 300 mm size and 0.4 μm thick, the amount of curing was evaluated as ∘ (good) when the curling (warpage) was less than or equal to 1 mm, and as × (poor) when the curling was more than 1 mm.

(8) Resistance of Transparent Electrode

A cured film 1 μm thick composed of a bisphenol A type epoxy resin and a Si particle (1:1) was formed on a thermoplastic resin film, and a SiO₂ film 60 nm thick was formed thereon by the high frequency discharge sputtering, and a transparent conductive film mainly composed of indium tin oxide (ITO) 100 nm thick was formed by direct current magnetron sputtering under the following condition.

The resistance was determined at room temperature using a Loresta MCP-TESTER-EP (available from Mitsubishi Chemical Corporation).

Target material: ITO (SnO₂: 10 wt. %)

Supplied gas in sputtering: Ar and O₂

Degree of vacuum in sputtering: 2.0×10⁻³ Torr

Supplied power: 1.5 kW

Substrate temperature: 120° C.

Sputtering rate: 10 nm/minute

(9) Irregularity of Film Thickness

The thickness of a sample film 30 mm wide and 10 m long sampled in the longitudinal direction of a film was continuously measured, using a film thickness tester (available from Anritsu Corporation, under the trade name of “KG 601A”). The sample film was transferred at a rate of 3m/minute in the measurement. The irregularity of thickness was determined according to the following equations:

R=Tₘₐₓ−Tₘᵢₙ

Irregularity of thickness (%)=[R/Tₐᵥₑ]×100

where Tₘₐₓ is the maximum (μm) of the thickness; Tₘᵢₙ is the minimum (μm) of the thickness; and Tₐᵥₑ is the average thickness (μm) in the film sample 10 m long.

(10) Thermal Expansion Coefficient α

With reference to ASTM D696, a sample strip 5 mm wide was placed in a constant-load tension tester in a thermo-hygrostat at a chuck distance of 150 mm long, and the sample was raised in temperature from 30° C. to 200° C. at a temperature rising rate of 2° C./minute at a relative humidity of 65%, and in this procedure, the thermal expansion coefficient (10⁻⁶/° C.) was defined as the average slope of the deformation amount. The range of the temperature was set in a range excluding the transition temperature.

(11) Oxygen Permeability

The oxygen permeability was determined at 23° C. at a relative humidity of 0% using an apparatus “OX-TRAN 2/20” (available from MOCON), according to the method described in ASTM D3985, and was indicated in cc/m²·day·sheet.

(12) Water Vapor Permeability

The water vapor permeability was determined at 40° C. at a relative humidity of 90% using an apparatus “PERMATRAN-WIA” (available from MOCON), according to the method described in Japanese Industrial Standards (JIS) K7129B, and was indicated in g/m²·day·sheet.

(13) Light Transmittance

The total light transmittance of visible light in a wavelength range of from 300 to 700 nm was determined using a spectrophotometer (available from Hitachi, Ltd., under the trade name of “U-3410”), and the light transmittance was defined as the light transmittance at a wavelength of 550 nm.

(14) Warpage

The warpage was determined according to the method described in JIS K6911.

(15) Surface Resistance

The resistance between a main electrode and a guard electrode was determined at 25° C. at a relative humidity of 65% at an applied voltage of 100V using a digital ultra-high resistance microammeter (available from Advantest Corporation, under the trade name of “R8340A”) with a three-terminal electrode. In this procedure, a counter electrode was grounded. The surface resistance was indicated in Ω/□.

(16) Abrasion Resistance

The abrasion resistance was evaluated by the easiness in the formation of scuff on the surface of a sample caused by #1000 steel wool abrasion.

(17) Pencil Hardness

A sample film was scratched by pencils of different hardness at an angle of 90 degrees under a load of 1 kg according to the method described in JIS K5400, and in this procedure, the pencil hardness was defined as the minimum hardness of the pencil which caused a scratch.

The present invention will be illustrated in further detail with reference to several examples and comparative examples below, which is not intended to limit the scope of the invention.

### EXAMPLE 1

As the thermoplastic resin, an alicyclic polyolefin (available from Nippon Zeon Co., Ltd., under the trade name of “ZEONOR”; glass transition temperature: 163° C.) was dried at 130° C. in vacuum for 4 hours, and was fed to an extruder A and was melted at 280° C.

As the thermoplastic resin B, poly(ethylene terephthalate) having an intrinsic viscosity of 1.4 dl/g was dried at 180° C. in vacuum for 6 hours, was fed to an extruder B and was melted at 280° C., and the molten thermoplastic resin B was laminated in an adapter on both sides of the thermoplastic resin A fed from the extruder A to yield a three-layer laminate (thermoplastic resin B/thermoplastic resin A/thermoplastic resin B), and was then discharged from a die to yield a molten sheet. The molten sheet was brought into close contact with a chromium-plated roll held at 70° C. and was cooled and solidified to thereby yield a laminated film having a lamination thickness ratio (B/A/B) of 50 μm/400 μm/50 μm. Next, the thermoplastic resin Layer B was peeled off at a peel force of 10 g/cm and the resulting Layer A was aged at 145° C. for 24 hours. The properties of the resulting film composed of the thermoplastic resin A are shown in Table 1.

### EXAMPLE 2

A film composed of the thermoplastic resin A was prepared in the same manner as in Example 1, except that the lamination ratio was changed to that indicated in Table 1, a thermoplastic resin B having an intrinsic viscosity of 1.0 dl/g was used, and the film was aged at 145° C. for 48 hours. The properties of the resulting film composed of the thermoplastic resin A are shown in Table 1.

### COMPARATIVE EXAMPLE 1

A film composed of the thermoplastic resin A was prepared in the same manner as in Example 1, except that the film was not aged. The properties of this film are shown in Table 1.

### EXAMPLE 3

As the thermoplastic resin A, an alicyclic polyolefin (available from Nippon Zeon Co., Ltd., under the trade name of “ZEONOR”; glass transition temperature: 163° C.) was dried at 130° C. in vacuum for 4 hours, and was fed to an extruder A and was melted at 280° C.

As the thermoplastic resin B, poly(ethylene terephthalate) having an intrinsic viscosity of 1.4 dl/g was dried at 180° C. in vacuum for 6 hours, was fed to an extruder B and was melted at 280° C., and the molten thermoplastic resin B was laminated in an adapter on both sides of the thermoplastic resin A fed from the extruder A to yield a three-layer laminate (thermoplastic resin B/thermoplastic resin A/thermoplastic resin B), and was then discharged from a die to yield a molten sheet. The molten sheet was brought into close contact with a chromium-plated roll held at 70° C. and was cooled and solidified to thereby yield a laminated film having a lamination thickness ratio (B/A/B) of 50 μm/400 μm/50 μm.

Next, Layer B was peeled off from one side of the laminated film, and the surface of the resulting Layer A was subjected to corona discharge treatment, and a reactive vapor deposition layer composed of alumina was formed thereon as a transparent vapor deposition layer, and a gas barrier layer was formed on the vapor deposition layer using a coating composition. The coating composition was a water-alcohol dispersion containing 45% by weight of poly(vinyl alcohol), 55% by weight of spherical colloidal silica sol (silica solid content: 10% by weight) having an average particle size of 13 nm, and acetylacetonatoaluminium as a crosslinking agent. The applied coating composition was cured at 150° C. to form a gas barrier layer 1 μm thick, and the film was then wound around a roll.

Additionally, a hard coat layer was formed on the gas barrier layer. Specifically, a composition containing 30% by weight of an acrylic resin and 70% by weight of spherical colloidal silica having an average particle size of 45 nm was applied on the gas barrier layer and was cured by ultraviolet ray (UV) to yield a hard coat layer 2 μm thick.

A gas barrier layer and a hard coat layer were successively formed on the other side of Layer A in the same manner as above after peeling off Layer B, to thereby yield a five-layer structure of hard coat layer/gas barrier layer/Layer A (thermoplastic resin A)/gas barrier layer/hard coat layer. The resulting laminated was cut into sheets 300 times 300 mm size, and 500 plies of the sheets were laminated to yield a laminate, and this laminate was aged at 145° C. under a load for 12 hours. The properties of the resulting film are shown in Table 1.

TABLE 1

| | | | | Enthalpy | | | |
|---|---|---|---|---|---|---|---|
| | | | | relaxation | | | |
| | | | | temperature | | Thermal | |
| | Lamination | Glass | | (° C.) | | dimensional | |
| | ratio | transition | | magnitude of | Surface | changing | Amount of |
| | (B/A/B) | temperature | Retardation | relaxation | roughness | temperature | curling |
| | (μm) | (° C.) | (nm) | (kJ/mol) | (nm) | (° C.) | (mm) |
| Example 1 | 50/400/50 | 166 | 0.5 | 175 | 25 | 180 | ∘ (0) |
| | | | | 0.35 | | | |
| Example 2 | 10/200/10 | 168 | 1.5 | 178 | 35 | 170 | ∘ (0) |
| | | | | 0.45 | | | |
| Example 3 | 50/400/50 | 166 | 0.5 | 175 | 25 | 183 | ∘ (0) |
| | | | | 0.35 | | | |
| Comp. Ex. 1 | 50/400/50 | 166 | 8 | — | 60 | 145 | X (3) |
| | | | | 0 | | | |

### EXAMPLE 4

As the thermoplastic resin A, an alicyclic polyolefin (available from JSR, under the trade name of “ARTON”; intrinsic viscosity: 0.67 dl/g, glass transition temperature Tg: 171° C.) was dried in a conventional manner and was fed to a tandem melt extruder of a diameter 250 mm, and was melted at 320° C. Separately, as the thermoplastic resin B to be laminated on and peeled off from the thermoplastic resin A, a poly(ethylene terephthalate) resin having an intrinsic viscosity of 1.25 dl/g and a glass transition temperature Tg of 70° C. was dried in a conventional manner, was fed to an melt extruder of a diameter 65 mm and was melted at 280° C. The two molten resins were respectively filtrated through a filter to remove foreign substances of 15 μm or more, and were laminated with each other in a lamination adapter to thereby yield a three layer structure of B/A/B, and the resulting laminate was extruded from a T-die of a ruling pen shape 2200 mm wide into a sheet on a cast drum at a distance of 50 mm from the die. In this procedure, the laminate was wound at a rate of 30 m/minute in close contact around a mirror-finished chromium-plated drum (drum diameter: 1800 mm, surface maximum roughness Rt: 0.1 μm) held at 60° C. using an air chamber to thereby cool and solidify the resins. The laminate was discharged and was wound in such a manner that the flowing direction of the molten fluid (molten laminate) in the land unit of the die became coincide with the winding direction of the molten laminate as much as possible. Specifically, a sloped die at an angle of 30 degree with respect to the horizontal line was used.

The above prepared cast film had a three layer structure composed of 30 μm/200 μm/30 μm and had a total thickness of 260 μm. This cast film was low in irregularity of thickness as of less than or equal to 2% in the longitudinal direction and in the widthwise direction, and had satisfactorily uniform thickness, since it exhibited no irregularity of thickness of 3 to 10 Hz as determined by frequency analysis of the irregularity of thickness. Additionally, the film was an amorphous sheet having satisfactory flatness without surface defects such as craters or die lines, and its edges had no variation in width, and the film was transparent and completely amorphous and had satisfactory casting property.

Layer B was peeled off from one side of the three-layer film, and the film surface of Layer A composed of the thermoplastic resin A was subjected to corona discharge treatment, and a gas barrier coating composition was applied thereon and was cured at 150° C. to thereby yield a gas barrier coating 1 μm thick, and the resulting laminate was wound around a roll. The gas barrier composition was a water-methanol dispersion containing 45% by weight of poly(vinyl alcohol), 55% by weight of a spherical colloidal silica having an average particle size of 13 nm, and acetylacetonatoaluminium as a crosslinking agent and catalyst.

A hard coat composition was further applied onto the gas barrier layer, and water was removed by drying, and the layer was cured by UV to thereby yield a hard coat layer 2 μm thick, and the resulting laminate was wound around a roll. The hard coat composition contained 30% by weight of an acrylic resin, and 70% by weight of a spherical colloidal silica having an average particle size of 45 nm.

The resulting three-layer laminated film was composed of a gas barrier layer G and a hard coat layer H successively formed on one side of a film of the thermoplastic resin A, and Layer B was peeled off from the side of this film not coated with the layers G and H, and the resulting exposed surface of Layer A was subjected to continuous corona discharge treatment, and two plies of the treated surfaces were overlapped with each other at 180° C. while evacuating the air by nip pressure to thereby yield a six-layer multilayer laminate composed of H/G/A/A/G/H. The multilayer laminate was cut into sheets 300 times 400 mm size. Next, 500 plies of the sheets were laminated to yield a laminate, and the laminate was heated and pressed at 230° C. to thereby improve flatness and adhesion between Layers A.

In the resulting laminate, the thermal expansion coefficients a were 55×10⁻⁶/° C. in Layer A, 20×10⁻⁶/° C. in Layer G, and 12×10⁻⁶/° C. in Layer H, and this laminate had a gradient structure in thermal expansion coefficient.

A silicon oxide layer 0.05 μm thick was initially formed on Layer H of the multilayer laminated sheet, and then an indium tin oxide (ITO) layer 0.2 μm thick was formed on the silicon oxide layer using a sputtering apparatus at a substrate temperature of 200° C. The formed ITO film had a surface resistance of 15 Ω/□. The resulting multilayer laminate was not curled and the ITO film exhibited no defects such as cracks or wrinkles.

The above-prepared multilayer laminate can be used as a substrate for mobile phone display screen, personal computer display screen, and other liquid crystal display devices, and is specifically useful in the application for color display in large-screen and other applications in which high optical properties are required.

### EXAMPLE 5

A three-layer laminated sheet composed of B/A/B was prepared in the same manner as in Example 4, except that the thickness of Layer A was changed to 400 μm instead of 200 μm. Layers B were then peeled off from the both sides of the sheet, and a gas barrier layer G and a hard coat layer H were successively laminated on the both sides of exposed Layer A, and the edges were knurled and the laminate was wound around a roll. The resulting laminate had a gradient structure in thermal expansion coefficient α as in Example 4. The laminate was then cut into sheets, and silicon oxide and ITO were sputtered thereon in the same manner as in Example 4.

The resulting multilayer laminated sheet had satisfactory optical properties.

### COMPARATIVE EXAMPLE 2

An ITO film was formed on a laminate in the same manner as in Example 4, except that the laminate had neither gas barrier layer G nor hard coat layer H, and ITO was directly sputtered onto Layer A. The resulting ITO film had wrinkles and cracks, and the substrate was curled, and the laminate could not be used in optical applications. This is probably because the laminate did not have a gradient structure in thermal expansion coefficient.

### EXAMPLE 6

As the thermoplastic resin A, an alicyclic polyolefin (available from Nippon Zeon Co., Ltd., under the trade name of “ZEONOR”; glass transition temperature of: 165° C.) was dried in vacuum in a conventional manner to remove moisture and oxygen, and the resin was fed to a vacuum extruder 150 mm in diameter and was melted at 285° C. The atmosphere in the vacuum extruder was replaced with nitrogen from a material hopper to the extruder. Separately, a mixture (apparent glass transition temperature Tg: 130° C.) was used as the thermoplastic resin B to be laminated on and peeled off from the thermoplastic resin A, which mixture comprised 30% by weight of a poly(ethylene terephthalate) resin (intrinsic viscosity: 0.65 dl/g, glass transition temperature Tg: 70° C.) and 70% by weight of a polycarbonate resin(glass transition temperature Tg: 150° C.). The thermoplastic resin mixture B was dried in vacuum in a conventional manner, was fed to a melt extruder 65 mm in diameter and was melted at 280° C. The thermoplastic resins A and B were respectively filtrated through a filter to remove foreign substances of 15 μm or more, and were laminated in a die to yield three layers of B/A/B, and the laminate was extruded from a T-die of a ruling pen shape 1200 mm wide onto the top of a cast drum at a distance of 50 mm from the die. The T-die was set so that the resins flowed in the horizontal direction. The flowing direction of the resins in the die land unit formed an angle of 0 degree with respect to the molten resin sheet. In this procedure, to improve adhesion between the drum and the resin sheet, the resin sheet was brought into close contact with the mirror-finished chromium-plated drum (drum diameter: 1800 mm, surface maximum roughness Rt: 0.1 μm) held at 140° C. from the grounding point at a rate of 30 m/minute using an air chamber to thereby cool and solidify. An air knife was used at both edges to further improve adhesion.

The above-prepared three-layer cast film had a thickness of 460 μm composed of 30 μm/400 μm/30 μm. The irregularities of thickness in the whole laminate and in Layer B were small of less than or equal to 3% both in the longitudinal direction and widthwise direction. Additionally, Layer A exhibited no irregularity of thickness at 3 to 10 Hz as determined by frequency analysis, and Layer B had satisfactorily uniform thickness and good flatness. The resulting Layer A had no surface defects such as craters and die lines, had a retardation of 3 nm and was a completely isotropic amorphous sheet 400 μm thick. The sheet exhibited no variation in width at its edges, and had a light transmittance of equal to or more than 90% in a range of from 400 to 700 nm, and was transparent and completely amorphous and had satisfactory optical isotropy.

Layer B was peeled off from one side of the three-layer film, and the surface of the exposed Layer A was subjected to plasma discharge treatment, and a gas barrier composition was applied thereon and was cured at 150° C. to thereby form a gas barrier layer 1 μm thick, and the resulting laminate was wound around a roll. As the gas barrier layer, a reactive vapor deposition layer composed of aluminum oxide (alumina) was formed as a transparent vapor deposition layer, and a gas barrier composition was applied on the transparent vapor deposition layer. The gas barrier composition was a water-methanol dispersion containing 45t by weight of a poly(vinyl alcohol), 10% by weight of a spherical colloidal silica having an average particle size of 13 nm, and acetylacetonatoaluminium as a crosslinking agent and catalyst.

A hard coat composition was further applied onto the gas barrier layer, and water was removed by drying, and the layer was cured by UV to thereby yield a hard coat layer 2 μm thick. The hard coat composition contained 30t by weight of an acrylic resin and 70% by weight of a spherical colloidal silica having an average particle size of 45 nm.

The resulting three-layer laminated film was composed of a gas barrier layer G and a hard coat layer H successively formed on one side of Layer A, and Layer B was then peeled off from the side of this film not coated with the layers G and H. A gas barrier layer and a hard coat layer were successively laminated on the exposed surface of Layer A after peeling off Layer B to thereby yield a multilayer laminate composed of five layers, H/G/A/G/H. The multilayer laminate was cut into sheets 300 times 400 mm size. Next, 500 plies of the sheets were laminated to yield a laminate, and the laminate was aged at 160° C. under an appropriate load for 10 hours. The resulting laminated sheet had a glass transition temperature Tg of 180° C., a retardation of less than or equal to 1 nm, a thermal expansion coefficient α of 30 ppm/° C. as determined at a relative humidity of 65% at temperatures ranging from 23° C. to 140° C., and a humidity expansion coefficient of 0.3 ppm/% as determined at 30° C. at relative humidity ranging from 30 to 80%, a center-line-average height (surface roughness) Ra of 2 nm, a Young's modulus of 200 kg/mm², an oxygen permeability of 0.1 cc/m²·day, a water vapor permeability of 0.2 g/m²·day, and a light transmittance of equal to or more than 92%.

On Layer H of the multilayer laminated sheet, a silicon oxide layer 0.05 μm thick and then a color filter RGB substrate were successively laminated, and an ITO layer 0.2 μm thick was laminated thereon using a known sputtering apparatus at a substrate temperature of 200° C. The resulting ITO film had a surface resistance of 15 Ω/□. The multilayer laminate was not curled, and the ITO film had no defects such as cracks and wrinkles.

The above-prepared multilayer laminate having satisfactory properties can be used as a substrate for mobile phone display screen, personal computer display screen, and other liquid crystal display devices, and is specifically useful in the application for color display in large-screen and other applications in which high optical properties are required.

### COMPARATIVE EXAMPLE 3

A sheet 400 μm thick was prepared in the same manner as in Example 6, except that the thermoplastic resin A alone was formed into a single layer without laminated surface resin B as in Example 6. The resulting sheet 400 μm thick was subjected to the measurement of retardation and observation of the surface to thereby find that this sheet had a markedly higher retardation of 21 nm as compared with the retardation (3 nm) of the sheet prepared through the lamination of Layer B. Additionally, the sheet in question exhibited a multiplicity of surface defects called as die lines on its surface.

Industrial Applicability

The present invention can provide a thermoplastic resin film having good surface flatness, low retardation and satisfactory thermal dimensional stability. The thermoplastic resin film can be specifically advantageously used as an optical film such as a substrate of liquid crystal display device, and polarizer-protective film. The substrate of liquid crystal display device according to the present invention has satisfactory optical isotropy, permits a transparent electrode formed thereon to have a low resistance, and has satisfactory flatness with less curling. This liquid crystal display device substrate is useful as a substrate for mobile phone display screen, personal computer display screen, and other liquid crystal display devices.

Other embodiments and variations will be obvious to those skilled in the art, and this invention is not to be limited to the specific matters stated above.

What is claimed is:

1. A thermoplastic resin film comprising at least a thermoplastic resin A having a glass transition temperature of equal to or higher than 150° C., said thermoplastic resin film having a thickness of equal to or more than 30 μm, a retardation of less than or equal to 20 nm, an enthalpy relaxation temperature of from 140° C. to 200° C. and an enthalpy relaxation magnitude of from 0.01 to 2.0 kJ/mol.

2. A thermoplastic resin film according to claim 1, wherein said thermoplastic resin A is selected from the group consisting of alicyclic polyolefins, polycarbonates, polyarylates, polysulfones, and poly(ether sulfone)s.

3. A thermoplastic resin film according to claim 1, wherein the thickness is equal to or more than 100 μm.

4. A thermoplastic resin film according to claim 1, wherein the thickness is equal to or more than 200 μm.

5. A thermoplastic resin film according to claim 1, wherein the retardation is less than or equal to 10 nm.

6. A thermoplastic resin film according to claim 1, wherein the retardation is less than or equal to 5 nm.

7. An optical film comprising a thermoplastic resin film of claim 1.

8. An optical film according to claim 7, wherein said optical film is used as a substrate for a liquid crystal display.

9. A process for producing a thermoplastic resin film, said process comprising the steps of:
laminating Layer B composed of a thermoplastic resin B at least on one side of Layer A composed of a thermoplastic resin A by melt co-extrusion, said thermoplastic resin A having a glass transition temperature of equal to or higher than 150° C.;
casting the resulting laminate into a film; and
peeling off said Layer B to thereby yield a thermoplastic resin film having a thickness of equal to or more than 30 μm, a retardation of less than or equal to 20 nm, an enthalpy relaxation temperature of from 140° C. to 200° C. and an enthalpy relaxation magnitude of from 0.01 to 2.0 kJ/mol.

10. A process according to claim 9, wherein said thermoplastic resin B is selected from polyesters and polycarbonates.

11. A process according to claim 9, wherein the laminate is cast into a film by the application of electro-pinning.

12. A process according to claim 9, wherein a gas barrier layer or a hard coat layer, or both are formed at least on one side of said Layer A to yield a laminate, and the laminate is cut to a sheet, and said sheet is aged at a temperature of lower than or equal to the glass transition temperature.

13. A laminate comprising:
Layer A composed of a thermoplastic resin A; and
Layer C comprising plural layers each having a thermal expansion coefficient lower than the thermal expansion coefficient α of said thermoplastic resin A, said Layer C being laminated on said Layer A in such a manner that said plural layers each have a sequentially decreasing thermal expansion coefficient with an increasing distance from said Layer A.

14. A laminate according to claim 13, wherein Layer C is laminated on both sides of said Layer A, said Layer C comprising plural layers each having a thermal expansion coefficient lower than the thermal expansion coefficient α of said thermoplastic resin A.

15. A laminate according to claim 13, wherein said laminate comprises bonded plural plies of component laminates, said component laminates each comprising Layer A and Layer C laminated on one side of said Layer A, said Layer C comprising plural layers each having a thermal expansion coefficient less than the thermal expansion coefficient α of said thermoplastic resin A, to thereby yield a laminate comprising Layer A and Layer C, said Layer C being laminated on both sides of said Layer A, and said Layer C having a thermal expansion coefficient less than the thermal expansion coefficient α of said thermoplastic resin A.

16. A laminate according to claim 15, wherein the surfaces of two plies of Layer A are subjected to a surface activation treatment, and the treated surfaces are bonded with each other by thermocompression.

17. A laminate according to claim 15, wherein an adhesive is applied onto the surfaces of two plies of Layer A, and the applied surfaces are bonded with each other by action of the adhesive.

18. A laminate according to claim 15, wherein a layer of a resin being substantially the same with said thermoplastic resin A is laminated and bonded between two plies of Layer A by melt extrusion.
